(19) United States
(12) Patent Application Publication
(10) Pub. No.: US 2003/0031830 A1
(43) Pub. Date: Feb. 13, 2003

(54) Printed circuit boards and printed circuit board based substrates structures with multiple core layers

(76) Inventors: Ming Sun, Sunnyvale, CA (US); Mike C. Loo, San Jose, CA (US)

Correspondence Address: Corporate Patent counsel, Philips North America Corporation, 580 White Plains Road, Tarrytown, NY, 10591, US

(21) Appl. No.: 09/927,319

(22) Filed: Aug. 13, 2001

(51) Int. Cl. B32B 3/10

(52) U.S. Cl. 428/138

(57) ABSTRACT

A substrate structure, such as is used for printed circuit boards and printed circuit board based substrates for semiconductor devices comprises two PCB core layers with at least one laminate layer between the PCB core layers. Improved electrical performance is obtained and strip line configuration can be used to as compared to microstrip configuration with conventional structures. A reduction in high-frequency power distribution impediance is obtained and smaller parasitic parameters.

This invention relates to printed circuit boards and printed circuit board based substrates.

### BACKGROUND OF THE INVENTION

Conventional printed circuit boards consist of a core member or layer—generally referred to as PCB core laminate layer—and one or more additional layers laminated on either side of the core layer. Typically such circuit boards carry semiconductor devices, and have through connections between various metal layers formed on and between the various layers. In particular such structures are used for Flip Chip Ball Grid Array (FCBGA) and Plastic Ball Grid Array (PBGA) packages. A typical three layer structure is illustrated and described in U.S. Pat. No. 6,225,690 issued May 1, 2001.

More than one layer can be laminated on each side of the PCB core, for example a four-layer one PCB core consisting of one PCB core layer and two resin laminate layers on each side of the core. A six layer structure is also available with one PCB core layer and three resin laminate layers on each side of the core.

The present invention resides in the provision or use of two PCB core laminate layers. This provides an improved electrical performance for a four layer structure as presently used, without a significant increase in manufacturing cost. When only one PCB core laminate layer is used in a four layer structure only microstrip line configuration can be achieved. Using the present invention, strip line configuration can be achieved with five layers having two PCB core laminate layers, with a reduction in high-frequency power distribution impedance. With strip line configuration, the package will have smaller parasitic electrical parameters, which allows the device to operate at higher frequencies.

In accordance with the broadest concept of the invention, a substrate structure for semiconductor devices comprises two PCB core layers and at least one laminate layer between the PCB core layers. Metal traces are formed on the various surfaces of the layers, and vias are formed to provide for interconnection between metal traces on different layers. Normally two laminate layers are provided but more than two can be used. Additional laminate layers are optionally added on the top and/or bottom surfaces of top and bottom PCB core layers.

### BRIEF DESCRIPTION OF THE DRAWINGS

FIG. 1 is a diagrammatic cross-section through one form of substrate, in accordance with the present invention;

FIG. 2 is similar to FIG. 1 illustrating an alternative form of substrate;

FIG. 3 is again similar to FIG. 1 illustrating a further form of substrate.

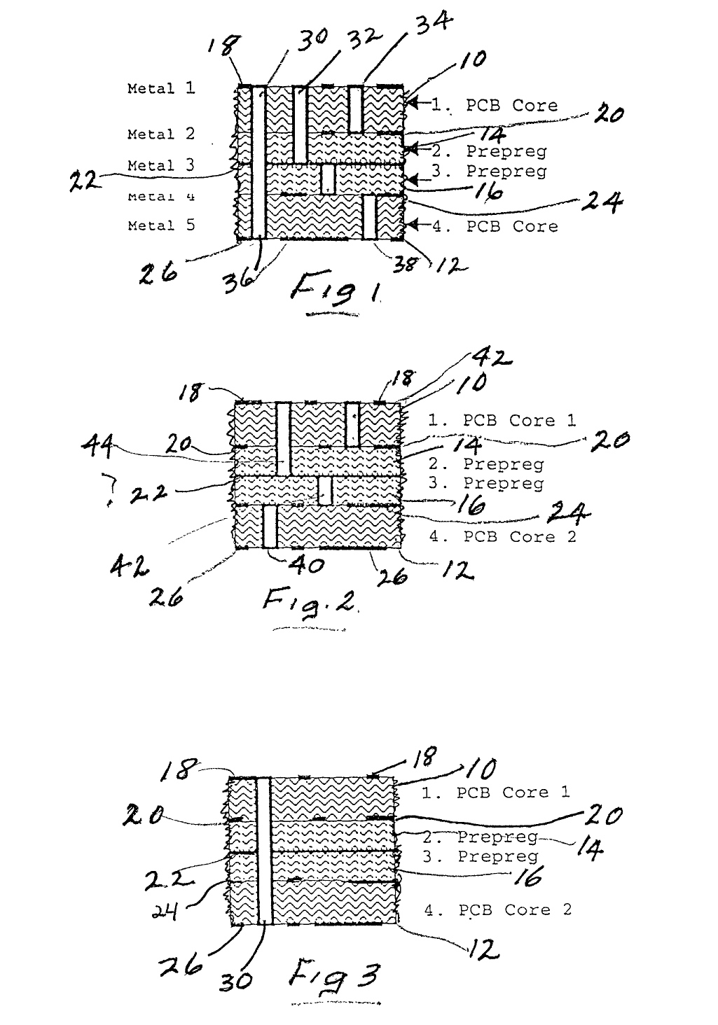

As illustrated in FIG. 1, one typical form of substrate comprises a first PCB core 10, a second PCB core 12 and two prepreg layers 14, 16 forming a laminate layer between the two PCB layers 10 and 12. As will be seen in FIG. 5 metal layers 18, 20, 22, 24, 26 can be provided. Various vias at through connections are provided at 30, 32, 34, 36 and 38.

There are numerous ways of producing the multiple PCB structures, as illustrated in FIGS. 2 and 3, with common reference numerals with FIG. 1 as applicable.

A first process or method, considering FIG. 2, is as follows:

(a) layout (developing, etching, stripping etc.) of metal layer 24 on layer 12 (PCB core) and drill layer 12, at 40, to provide via or connection;

(b) visual/electrical checking of layer 24;

(c) laminate the laminate layer 16 at the PCB core layer;

(d) layout (developing, etching, stripping, etc.) metal layer 22 on top surface of laminate layer 16 and drill from top surface of layer 16 to top surface of layer 12 to form via, or connection 42;

(e) layout (developing, etching, stripping, etc.) of metal layer 18 on layer 10 (PCB core);

(f) drill between top and bottom surfaces of layer 10 to form vias or interconnects 42;

(g) visual/electrical checking of layer 10;

(h) laminate layer 10 (PCB core), and laminate layer 14 to layers 16 and 12;

(i) drill between top surface of PCB core layer 10 and top surface of laminate layer 16 to form via or connection 44.

Another method or process is as follows, again referring to FIG. 2:

(a) layout (developing, etching, stripping etc.) of layer 12 (PCB core) and drill layer 12;

(b) visual/electrical checking of layer 12;

(c) laminate the laminate layer 16;

(d) layout (developing, etching, stripping, etc.) metal layer 22 on top surface of laminate layer 16 and drill from top surface of layer 16 to top surface of layer 12 to form via 42;

(e) layout (developing, etching, stripping, etc.) of metal layer 18 on layer 10 (PCB core);

visual/electrical checking of layer 10;

(f) drill between top and bottom surfaces of layer 10 to form via 42.

(g) laminate PCB core layer 10 and laminate layer 14;

(h) drill between top surface of layer 10 and bottom surface of layer 14 to form via 22;

(i) laminate PCB core layer 10 and laminate layer 14 to laminate layer 16 and PCB core layer 12;

A further method or process, referring to FIG. 3, is as follows; common reference numerals used when applicable:

(a) layout (developing, etching, stripping etc.) layer 10 (PCB core);

(b) visual/electrical checking of layer 10;

(c) layout (developing, etching, stripping, etc.) laminate layer 14;

(d) visual/electrical checking of layer 14;

(e) laminate layers 10 and 14;

(f) layout (developing, etching, stripping, etc.) layer 12 (PCB core);

(g) visual/electrical checking of layer 12;

(h) layout (developing, etching, stripping, etc.) layer 16;

(i) visual/electrical checking of layer 16; and

(j) laminate layers 10 and 14 to layers 16 and 12.

In this latter method, step (e) can be omitted and the layers all laminated at the same time, or some other laminating sequence used. After final laminating, the layers are drilled through to form the via 30.

Also, at some appropriate position in the method the bottom surface of layer 12 has the layout step (develop, etch, strip, etc.) applied, with visual/electrical checking.

It will be appreciated that there can be some variation in the actual carrying out of the various steps in the above described methods.

The forming of conducting layers in the vias will also be carried out at the appropriate times.

The PCB core layers 10 and 12 can be prepared individually, as far as possible. Also laminate layers 14 and 16 can be prepared individually, as far as possible. Then a sequence of laminating is carried out as suitable for the preparation of vias, etc.

The invention provides an improved electrical performance on multi layer structures, particularly, for example, over present four layers with one PCB substrate. This is achieved without a significant increase in manufacturing cost. Current structures can only achieve microstrip configuration, while with this invention strip line configuration can be achieved, with a reduction in the high-frequency power distribution impedance. With strip line configuration, the package will have smaller parasitic parameters, which enables the device to run faster.

The actual number of layers, PCB core layers and laminate layers can vary. The basis of the present invention is a structure comprising two PCB core layers, with at least one laminate layer between the PCB core layers. More than one laminate layer can be provided as shown in the figures and it is envisaged that one or more laminate layers can be provided on the top surface and/or bottom surface of PCB core layers 10 and 12 respectively.

For example, a six layer board is achieved by placing only a single laminate layer between the cores providing for two metal layers therebetween and by providing two metal layers on each of the top and bottom surfaces. Alternatively, three laminate layers are interprosed between the core layers providing four metal layers therebetween and only a single layer of metal need be deposited on each of the top and bottom. Of course, any number of combinations to achieve a given number of layers is possible in accordance with the present invention.

Numerous other embodiments may be envisaged without departing from the spirit or scope of the invention.

What is claimed is:

1. A substrate structure for semiconductor devices, comprising two PCB core layers and at least one laminate layer between the PCB core layer.

2. A substrate structure as claimed in claim 1, said PCB core layers comprising a first PCB core layer having top and bottom surfaces, a second PCB core layer having top and bottom surfaces, said laminate layer laminated between the bottom surface of the first PCB core layer and the top layer of the second PCB core layer.

3. A substrate structure as claimed in claim 2, including a metal layer on the top surface of the first PCB core layer, a metal layer a bottom surface of the first PCB core layer and a metal layer on the top surface of the second PCB core layer.

4. A substrate structure as claimed in claim 3, comprising another laminate layer disposed between the PCB core layers.

5. A substrate structure as claimed in claim 4, including a metal layer between the laminate layer and the another laminate layer.

6. A substrate structure as claimed in claim 4, including a metal layer on the bottom surface of the second PCB core layer.

7. A substrate structure as claimed in claim 3, including vias in the PCB core layers and laminate layer for electrical connection between metal layers.

8. A substrate structure as claimed in claim 2, including a metal layer on the top surface of the first PCB core layer, a metal layer on a bottom surface of the first PCB core layer and a metal layer on the bottom surface of the second PCB core layer.

9. A substrate structure as claimed in claim 8, comprising another laminate layer disposed between the PCB core layers.

10. A substrate structure as claimed in claim 9, including a metal layer between the laminate layer and the another laminate layer.

11. A substrate structure as claimed in claim 9, including a metal layer on the top surface of the second PCB core layer.

12. A substrate structure as claimed in claim 8, including vias in the PCB core layers and laminate layer for electrical connection between metal layers.

13. A substrate structure as claimed in claim 1, including a metal layer between the PCB core layers.

14. A substrate structure for semiconductor devices, comprising two PCB core layers and at least one metal layer between the PCB core layers.
